(19) United States
(12) Patent Application Publication
(10) Pub. No.: US 2026/0194901 A1
(43) Pub. Date: Jul. 9, 2026

(54) Augmented-Reality-Based Methods of Controlling a Mobile Robot in a Deployment Environment, and Related Software, Systems, and Mobile Robots

(71) Applicant: University of Vermont and State Agricultural College, Burlington, VT (US)

(72) Inventors: Alireza Fath, Essex Junction, VT (US); Dryver Huston, South Burlington, VT (US); Yi Liu, Burlington, VT (US); Tian Xia, South Burlington, VT (US)

(21) Appl. No.: 19/436,228

(22) Filed: Dec. 30, 2025

Related U.S. Application Data
(60) Provisional application No. 63/741,672, filed on Jan. 3, 2025.

(51) Int. Cl. G05D 1/2285; G05D 1/224; G05D 101/10; G05D 109/10; G06F 3/01; G06V 20/20; G06V 40/10; G06V 40/20

(52) U.S. Cl. CPC G05D 1/2285; G05D 1/2249; G06F 3/011; G06F 3/017; G06V 20/20; G06V 40/10; G06V 40/28; G05D 2101/10; G05D 2109/10

(57) ABSTRACT

Methods of controlling movements of a mobile robot having a mobility system for moving the mobile robot in a deployment environment, the mobility system being responsive to a plurality of movement commands. In an example of such methods, the method includes: providing, by a headset of an augmented-reality system to a user wearing the headset, a view of features within the deployment environment; capturing, by a first camera of the augmented-reality system, a first gesture that the user makes with the hand; translating the first gesture into at least one of the movement commands; and transmitting the at least one of the movement commands to the mobile robot. Related systems, software, and apparatuses are also disclosed.

### RELATED APPLICATION DATA

This application claims the benefit of priority of U.S. Provisional Patent Application Ser. No. 63/741,672, filed on Jan. 3, 2025, and titled “Augmented-Reality-Based Methods of Controlling a Mobile Robot in a Deployment Environment, and Related Software, Systems, and Mobile Robots,” which is incorporated by reference herein in its entirety.

### GOVERNMENT RIGHTS

This invention was made with government support under Grant 2119485 awarded by the U.S. National Science Foundation and Award W913E521C0003 from the Cold Regions Research and Engineering Laboratory of the U.S. Army Corps of Engineers. The government has certain rights in the invention.

### FIELD

The present disclosure generally relates to the field of microrobots. In particular, the present disclosure is directed to augmented-reality-based methods of controlling a mobile robot in a deployment environment, and related software, systems, and mobile robots

### BACKGROUND

Inspection of infrastructure, such as buildings, bridges, underground transportation structures, underground utility structures, etc., and manufactured items, such as aircraft, land vehicles, ships, spacecraft, etc., is important at many times over the lifecycles of such human-produced things. For example, inspection of infrastructure and manufactured items can be critical at the time of construction or manufacture to ensure they have been or are being manufactured correctly. As another example, infrastructure and manufactured items that are in service need to be inspected from time to time to ensure that components of these items have not degraded to the point that repair, replacement, removal from service, etc., is needed. In addition, with the continuing increase in use of building information modeling (BIM), digital twinning, and the like, the need to deploy systems for acquiring data, for example, visual images, thermal images, non-visual sensor data, etc., is similarly increasing.

### SUMMARY

In one implementation, the present disclosure is directed to a method of controlling, by a user having a hand, a mobile robot having a mobility system for moving the mobile robot in a deployment environment, wherein the mobility system is responsive to a plurality of movement commands to move the mobile robot. The method includes providing, by a headset of an augmented-reality system to a user wearing the headset, a view of features within the deployment environment; capturing, by a first camera of the augmented-reality system, a first gesture that the user makes with the hand; translating the first gesture into at least one of the movement commands; and transmitting the at least one of the movement commands to the mobile robot.

In another implementation, the present disclosure is directed to a machine-readable storage medium containing machine-executable instructions for performing the method described immediately above.

In yet another implementation, the present disclosure is directed to a microrobot for use on a surface, which includes a body; a plurality of flexible legs extending from the body, each of the flexible legs having a foot end designed and configured to contact the surface; a vibration generator engaged with the body so as to impart vibrations into the body, wherein the vibration generator is configured to operate in, serially, at least a first vibration mode having a first directionality and a second vibration mode having a second directionality different from the first directionality; and a steering controller in operative communication with the vibration generator that is designed and configured to switch between the first and second vibration modes in response to steering command signals; wherein, when implemented, the first and second vibration modes interact with the flexible legs to create steered locomotion of the microrobot.

### BRIEF DESCRIPTION OF THE DRAWINGS

For the purpose of illustration, the accompanying drawings show aspects of one or more embodiments of the disclosure. However, it should be understood that the scope of this disclosure is/are not limited to the precise arrangements and instrumentalities shown in the drawings, wherein:

FIG. 1 is a high-level block diagram illustrating an example mobile-robot (MR) system, made in accordance with aspects of the present disclosure, that uses an augmented-reality (AR) system to control movement of a mobile robot;

FIG. 2 is a perspective view of a microrobot that can be used as the mobile robot of the MR system of FIG. 1;

FIG. 3A is an enlarged elevational view of each leg of the microrobot of FIG. 2;

FIG. 3B is an enlarged transverse cross-sectional view as taken along line 3B-3B of FIG. 3A;

FIG. 4A is an elevational view of an example alternative leg that can be used for each of the legs of a microrobot of the present disclosure, such as the microrobot of FIG. 2, showing the leg as having rigid segments connected with one another via a flexible knee joint;

FIG. 4B is an elevational view of another example alternative leg that can be used for each of the legs of a microrobot of the present disclosure, such as the microrobot of FIG. 2, showing the leg as having rigid segments connected with one another via a flexible knee joint and as being connected to a body of a microrobot via a flexible hip joint;

FIG. 5 is a plan view of a deployment environment illustrating example movements that an example vibratory mobile robot, such as the microrobot of FIG. 2, can make under control of a user via an AR system, such as the AR system of FIG. 1;

FIG. 6 is a diagram illustrating an example gesture-control-based inspection scenario for allowing a user to control a mobile robot in a deployment environment;

FIG. 7A is an example snapshot-in-time view at a first time that a user wearing a headset of an AR system of the present disclosure would see, showing a virtual control panel and features of a virtual controller displayed to the user;

FIG. 7B is an example snapshot-in-time view at a second time different from the first time of FIG. 7A that the user wearing the headset of FIG. 7A would see, showing the user making a gesture that causes the AR system to generate a proceed rightwardly MR control command; and

FIG. 7C is an example snapshot-in-time view at a third time different from each of the first and second times of FIGS. 7A and 7B that the user wearing the headset of FIG. 7A would see, showing a livestream window that the headset displays when the user has selected the livestream toggle switch of the virtual control panel.

### DETAILED DESCRIPTION

The entire contents of the appended claims are incorporated into this Detailed Description section by reference and should be treated as if originally presented herein.

Unless noted otherwise, the modifiers “first”, “second”, “third”, “fourth”, and the like, do not denote any particular order or importance, location, priority, etc. Rather, these modifiers are used simply to differentiate elements that are the same as or similar to one another in a set of two or more of such elements.

### General

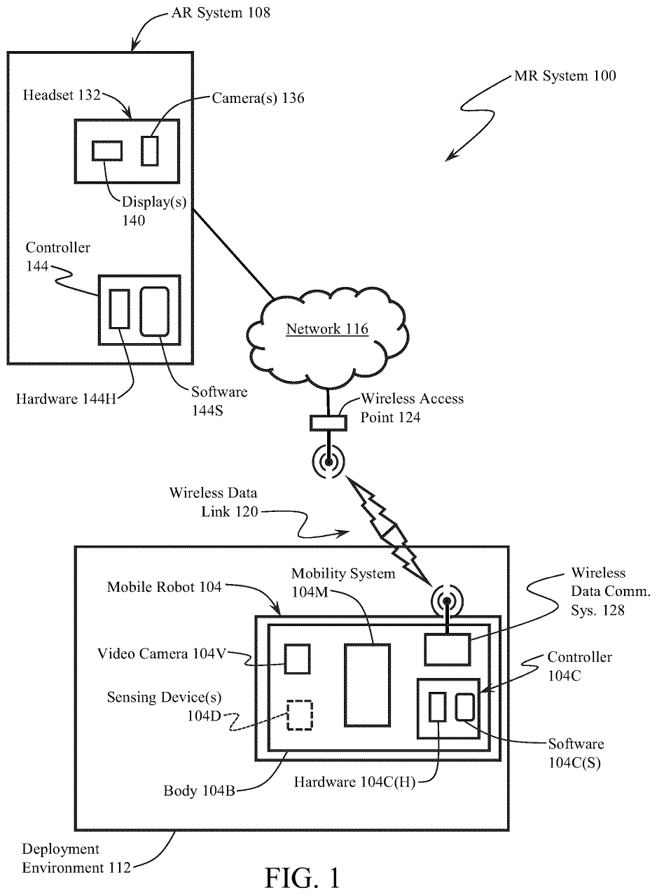

In some aspects, the present disclosure is directed to augmented-reality (AR) based control methods of controlling a mobile robot in a deployment environment, such as, for example, an inspection site of infrastructure or manufactured items that is difficult and/or dangerous to access, along with any pathway that the mobile robot needs to traverse to reach the inspection site, among many other deployment environments. Example infrastructure and manufactured items that can be or include a deployment environment of the present disclosure include, but are not limited to, buildings, bridges, underground transportation structures, underground utility structures, aircraft, land vehicles, ships, and spacecraft, and one or more components of each, among many others. Fundamentally, there are no limitations of the nature and character of a deployment environment of the present disclosure other than it, including any access pathway needed for accessing the deployment environment, be navigable by a suitable configured mobile robot. An AR-based control method of the present disclosure may be performed in any suitable mobile-robot (MR) system, such as the MR system 100 of FIG. 1. For example, an AR-based control method of the present disclosure may allow one or more users to implement AR teleoperation of a mobile robot. In an example instantiation of such an AR-based control method, edge computing aided by a wireless connection translate a user's finger movements to mobile robot movements.

Referring to FIG. 1, the example MR system 100 includes a mobile robot 104 and an AR system 108 that allows a user (not shown) to control the mobile robot in a deployment environment 112 using hand predetermined gestures that the MR system is configured to recognize and respond to in generating and sending control signals to the mobile robot. In this example, the MR system 100 is a network-based system that operates over a network 116 that includes a wireless data link 120 between the AR system 108 and the mobile robot 104. As those skilled in the art will readily appreciate, the network 116 may be any suitable data-communications network. As a nonlimiting example, the network 116 may include a wide-area network (WAN), the Internet, and/or a cellular network, among others. In some embodiments, the wireless data link 120 may include a wireless access point 124, connected to the network 116, that utilizes any suitable communications technology, such as, for example, a long range WAN (LoRaWAN) technology based on non-licensed frequencies or a technology based on one or more other wireless data link protocols, such as, but not limited to, ZIGBEE®, WI-FI®, BLUETOOTH®, LTE, 5G/6G, and STARLINK® protocols, among others. Corresponding to the wireless access point 124, in this example, the mobile robot 104 has a wireless data-communications system 128 that uses the same technology and protocol as the wireless access point. As described below in more detail, the wireless data link 120 carries control commands for controlling the mobile robot 104, streaming video from the mobile robot, and, to the extent present, non-video sensor data from the mobile robot.

In this example, the AR system 108 includes a headset 132 that the user wears during use of the MR system 100. The headset 132 includes one or more cameras 136 that provide(s) live images of the user's immediate environments, including, when the user desires, one, the other, or both, of the user's hands so as to effect the gesture-based control of the mobile robot 104, and, when circumstances allow, any portion(s) of the deployment environment 112 that may be visible from the user's vantage point. The headset 132 also includes one or more visual displays 140 that display images to the user, such as live images from the onboard camera(s) 136 and/or images of live-stream video received from the mobile robot 104, and may also include transparent lenses that allow the user to view their immediate environment, including any portion(s) of the deployment environment 112 that may be visible from the user's vantage point. Each visual display 140 may be any suitable visual display for AR systems and are well-known in the art.

The AR system 108 further includes a controller 144 that provides all functionality of the AR system, including, but not limited to controlling the visual display(s) 140, controlling the camera 136, controlling communications over the wireless data link 120, analyzing user gestures, and generating MR control commands, among other things. The controller 144 may be located in any suitable location, such as aboard the headset 132, in a separate console (not shown), or a server (not shown) connected to the network 116, among others. When the controller 144 is not integrated with the headset 132, the headset may be wiredly or wirelessly operationally connected to the controller. The controller 144 may include any suitable hardware 144H that includes, for example, one or more processors of any suitable type (e.g., FPGA, general purpose, ASIC, system on chip, custom chip, etc.) and memory of any one or more types (e.g., RAM, ROM, cache, persistent, magnetic, bubble, etc.), with the memory storing software 144S, that is, machine-executable instructions, encoding methods/algorithms for controlling the headset 132 and other functions of the MR system 100, such as generating MR control commands for controlling the mobile robot 104. As used herein and in the appended claims, the term “machine-readable storage medium” denotes hardware memory of any one or more types and does not include transitory signals, such as digital information encoded onto a carrier wave or into a pulsed signal. In an example, the hardware and some of the software of the AR system 108 may be the HOLOLENS® mixed-reality technology available from Microsoft Corporation, Redmond, Washington.

The form of the mobile robot 104 may be any suitable form, such as, but not limited to: a terrestrial form (e.g., legged, wheeled, tracked, etc.); an aerial form, such as unpersoned aerial vehicle (UAV) (e.g., a propellered drone, a micro-insect, etc.); and a submersible form, such as an autonomous underwater vehicle (AUV), a remotely operated vehicle (ROV), etc.; among others, and any combination thereof. At a high level, the mobile robot 104 includes a body 104B, a mobility system 104M, and a controller 104C. The body 104B may take any suitable form, such as a chassis-based form, an open or closed spaceframe form, or a unibody form, among others. Generally, the body 104B typically provides a platform for the mobility system 104M and any sensing device(s), located onboard the mobile robot 104.

The mobility system 104M may be, for example, any suitable mobility system such as an airborne mobility system for moving the mobile sensing robot through the air, a submersible propulsion system for moving the mobile sensing robot through water or other liquid (e.g., liquid petroleum products, liquid chemical products, sewage, etc.), or a traction system for moving the mobile sensing robot on one or more surfaces, including a surface of the material being tested, or any combination thereof. The mobility system 104M allows the mobile robot 104 to be deployed to the deployment environment 112 using gesture-based control commands that the AR system 108 generates in response to gestures that the user makes. In some embodiments, the mobility system may be a mobility system specially adapted for a specific type of deployment. In some embodiments, a traction-type mobility system may be more generally designed for deployments having various types of surfaces. In this connection, example surfaces include solid surfaces, smooth surfaces, rough surfaces, uneven surfaces, hard surfaces, and soft surfaces, among many others.

In some embodiments, the traction-type mobility system 104M may include two or more traction elements (not shown) of any suitable type(s). For example, the traction elements may be passive or active ambulatory legs having corresponding feet for intermittently engaging a surface during ambulation, wheels having surface-engaging elements (e.g., smooth surfaces or treads), and tracks (e.g., chain-or belt-type) having surface-engaging elements (e.g., smooth surfaces or treads), among others, and any combination of these traction elements. The traction elements may be driven by one or more suitable actuators (e.g., electromechanical, pneumatic, hydraulic, electromagnetic, etc.) or motors (e.g., stepper motor, servomotor, etc.), among others.

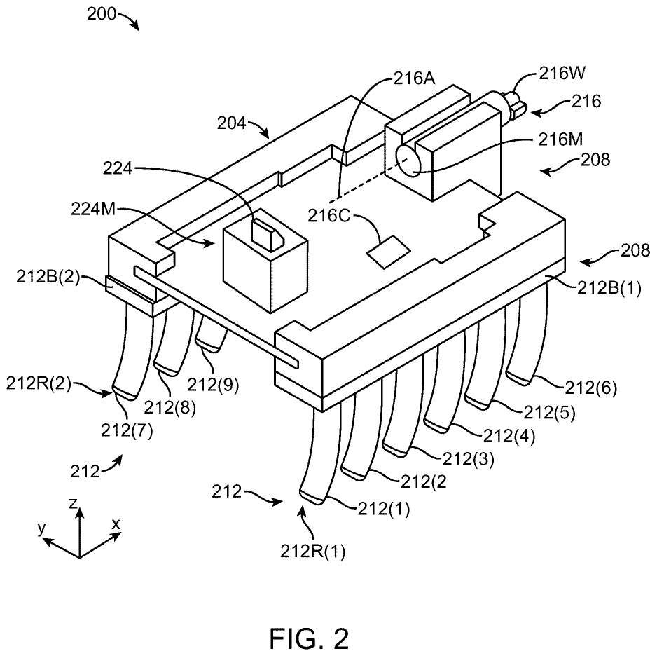

Each traction element may include one or more contact surfaces for contactingly engaging a surface (not shown) to which the corresponding mobile sensing robot is deployed, with such contact surfaces being designed and configured to provide characteristics (e.g., friction, compliance, treading, etc.) suitable for allowing the mobility system 104M to move the mobile robot 104 on each surface at issue. In some embodiments, each traction element may include one or more engagement-enhancing features (not shown) for enhancing the engagement of the traction element with certain types of surfaces. Examples of engagement-enhancing features include, but are not limited to, electromagnets for traversing surfaces of ferromagnetic materials, suction devices for traversing relatively smooth surfaces, and gripping elements for gripping and releasing graspable features that may form a traversed surface or are otherwise present on or in the traversed surface. Other types of engagement-enhancing features are possible and can be tailored to the use application at hand. FIG. 2 illustrates an example mobile robot 200 having a traction-type mobility system 208.

Referring still to FIG. 1, in some embodiments of an airborne-type mobility system, the mobility system 104M may be, for example, of a helicopter-rotor-type or of a flapping-wing-type, such as used in robotic micro-insects. In some embodiments, the mobile robot 104 of the present disclosure having an airborne mobility system (not shown) may have passive landing gear, e.g., legs, feet, wheels, etc., or a complementary traction system.

In some embodiments of a submersible-type mobility system, the mobility system 104M may be a propulsion system of a propeller-type or of a jet type. As those skilled in the art will readily appreciate, embodiments of the mobile robot 104 having a submersible-type system can be deployed for any one or more of a variety of purposes, such as, but not limited to, inspecting submerged structures or submerged parts of structures (e.g., storage tanks, sewage-processing tanks and basins, offshore structure, ship hulls, etc.) and/or measuring one or more aspects of the relevant liquid (e.g., temperature, turbidity, contamination, etc.), among other things.

The mobile robot 104 may include one or more sensing devices, such as one or more sensing devices for performing inspection while the mobile robot is in the deployment environment. In some embodiments, the mobile robot 104 includes a video camera 104V for performing real-time visual inspection and/or for providing real-time images to the user of the AR system 108 so that the user can control the mobility system 104M so as to control movement of the mobile robot. The mobile robot may include one or more sensing devices other than the video camera 104V, with such other sensing device(s) being singly and collectively represented at sensing device 104D in FIG. 1. Each sensing device 104D may be any sensing device for the task at hand, such as, but not limited to, a thermal imager, a temperature probe, an aural-sensing device, a moisture-sensing device, a vibration-sensing device, a material-penetrating radar device, an ultrasound device, and a navigational sensor (e.g., a global-positioning-system sensor, or an inertial-measurement-sensor, etc.), among others. Fundamentally, there is no limitation on the type of sensing device(s) other than the video camera 104V that the mobile robot 104 may include.

The controller 104C aboard the mobile robot 104 in this example may act as a central controller of sorts for controlling the mobility system 104M, the wireless data communications system 128, the video camera 104V, and any other sensing device(s) 104D, that may be onboard the mobile robot. The controller 104C may include hardware 104C(H) that, during operation, executes software 104C(S) that embodies, among other things, methods and algorithms for performing the requisite functions. Those skilled in the art will readily understand the methods and algorithms that any given instantiation of the mobile robot 104 will require. The hardware 104C(H) may be any suitable hardware that includes, for example, one or more processors of any suitable type (e.g., FPGA, general purpose, ASIC, system on chip, custom chip, etc.) and memory of any one or more types (e.g., RAM, ROM, cache, persistent, magnetic, bubble, etc.), with the memory storing machine-executable instructions encoding methods / algorithms for controlling components aboard the mobile robot 104, such as, but not limited to, receiving MR control commands via the wireless data communications system 128 and causing the relevant control aboard the mobile robot.

As indicated above, a user can control the mobile robot 104 via the AR system 108 using hand-gesture-based commands that the user issues. Such control can include controlling the operation of the mobility system 104M so as to control movement of the mobile robot 104 within the deployment environment and/or controlling operation of one or more of the sensing device(s) onboard the mobile robot, such as the video camera 104V and any one or more of any one or more additional sensing devices that may be onboard the mobile robot. At a high level and in an example, the AR system 108 is configured so that, when the user places at least one of his/her hands into the field of view of the video camera(s) 136 aboard the headset 132, it can discern gestures that the user makes with his/her hand(s) or portion(s) thereof, classify such gestures, generate MR control commands, and cause the wireless access point 124 to send the MR control commands to the mobile robot 104 via the wireless data link 120. In this connection, the software 144S of the controller 144 of the AR system 108 contains, among other things, virtual-controller software, object-recognition algorithms, gesture-recognition algorithms, gesture-classification algorithms, MR-control-command-generating algorithms, and MR-control-command-communicating algorithms for performing the above-identified tasks relative to controlling the mobile robot 104. A detailed example of controlling the traction-type mobility system 208 of the example mobile robot 200 of FIG. 2, including example gestures for effecting such controlling, is described in the EXAMPLE EMBODIMENTS section below.

The foregoing and other embodiments are exemplified in the following section.

### Example Embodiments

With the foregoing in mind, this section describes some example embodiments that combine various features, elements, and components discussed above. These examples are not intended to cover all possible combinations and permutations of the features, elements, and components discussed above. Rather, they are simply illustrative of manners in which the foregoing features, elements, and components can be combined with one another and results that can be achieved therefrom.

FIG. 2 shows an example microrobot 200 that can be used as the mobile robot 104 of FIG. 1. In the example of FIG. 2, the microrobot 200 includes a body 204 and a traction-type mobility system 208 that includes a plurality of legs 212, here twelve legs 212(1)-212(12) (not all seen in FIG. 2) and a vibration generator 216. In this example, the legs 212 of the microrobot 200 are arranged in two rows 212R(1) and 212R(2) each having a set of six legs. In other embodiments, the legs 212 may be arranged differently and/or provided in a number greater or fewer than twelve. In this embodiment, each set of six legs 212 is integrally formed with, for example, by 3D printing or molding, a leg base 212B(1) and 212B(2), which in turn is fixedly attached to the body 204 in any suitable manner, such as by adhesive bonding. In other embodiments, each leg 212 may be coupled to the body 204 in another manner, such as by insertion into a suitable receptacle (not show).

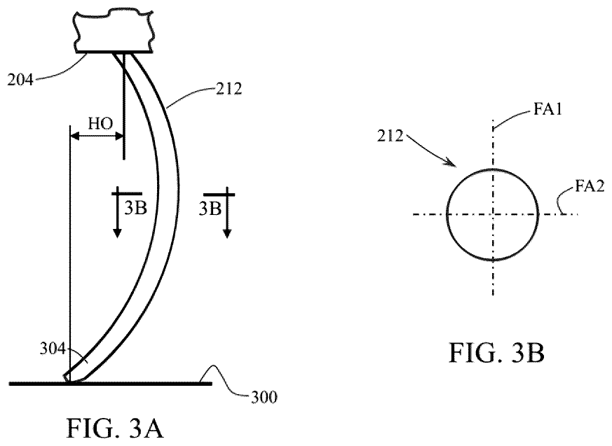

In the embodiment shown, each leg 212 is at least partly made of a flexible material that gives the leg a measure of flexural compliance along its length and about at least one flexural axis. FIG. 3A illustrates each leg 212 in isolation from the other legs, showing its length along a built-in curvature, as well as a horizontal offset (HO), in the direction of curvature relative to the point of attachment of the leg to the body 204, needed to effect proper operation of the microrobot 200 (FIG. 2). The length and curvature are designed in conjunction with various parameters, such as the weight of the microrobot 200 (FIG. 2) carried by the legs 212, the total number of legs that carry the weight of the microrobot, the operating characteristics of the vibration generator 216, and the characteristics of each surface 300 (FIG. 3A) on which the microrobot is designed to be deployed. As seen in FIG. 3B, each leg 212 has a circular cross-sectional shape to cause the leg to provide a desired response to vibrations that the vibration generator 216 (FIG. 2) imparts into the microrobot 200 during its operation.

As best seen in FIG. 3A, each leg 212 has a foot 304 that, during operation, contacts the surface 300, with the foot being made of any material that is sufficiently durable and provides sufficient contact friction so that the microrobot 200 (FIG. 2) can properly move along the surface. In some embodiments, the material used to make each leg 212 may be such that it provides not only the desired flexural properties about a pair of flexural axes FA1 and FA2 (as shown on FIG. 3B), but also sufficient contact friction with the surface 300 such that the foot 304 (FIG. 3A) need not be made of any material different from the material of the leg. For example, certain polymers may allow each leg 212, including the foot 304, to be made of only a single material. In some embodiments, the material(s) used for each leg 212 may not provide the contact friction needed with the surface 300. For example, each leg 212 may be made of a spring steel, which would provide little contact friction when the surface 300 is made of a hard and smooth material. In such cases, the foot 304 (FIG. 3A) may be made using a higher-friction material, such as a polymer or rubber, among others. Other materials can be used for each leg, such as a high-durometer rubber or a fiber-reinforced composite, among others. Fundamentally, there is no limitation on the material(s) of which each leg is made.

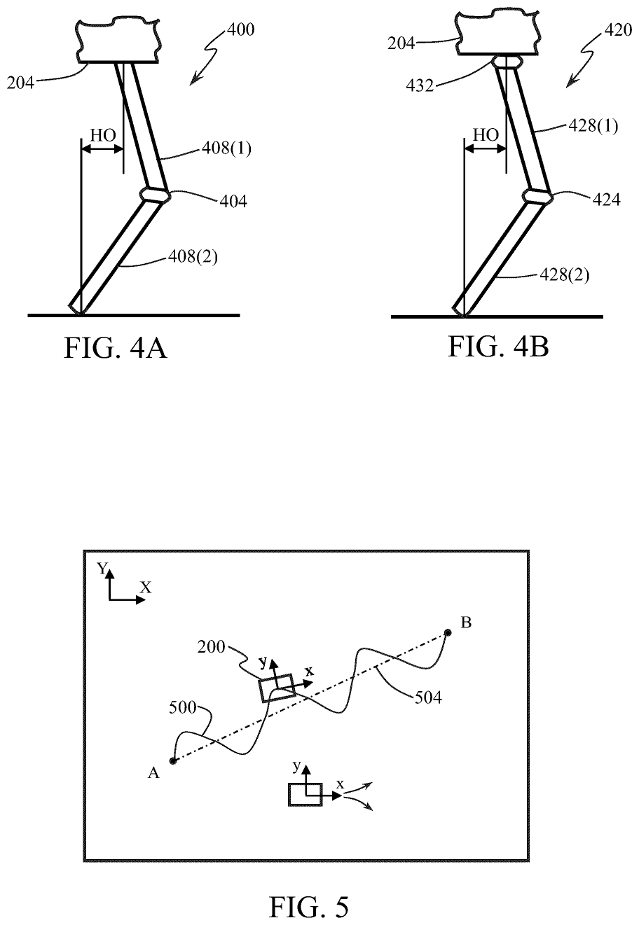

It is also noted that flexural compliance of each leg 212 can be imparted in a way other than making the leg from a suitable material along most of all of its length. For example, each leg may be made of one or more rigid segments, with compliance provided by one or more joints that secure the leg to the body and/or secure pairs of adjacent segments to one another. For example, FIG. 4A shows a leg 400 having a “knee” joint 404 connecting together two non-flexurally compliant leg segments 408(1) and 408(2), with the knee joint being made of a compliant rubber that provides the leg with the desired compliance to enable mobility. As another example, FIG. 4B shows a leg 420 having both a knee joint 424 connecting together two non-flexurally compliant leg segments 428(1) and 428(2) and a “hip” joint 432 connecting the leg segment 428(1) to the body 204 of the microrobot 200 (FIG. 2). In this example, both the knee and hip joints 424 and 432 may be made of a suitable material, such as a compliant rubber, that provides the leg with the desired compliance to enable mobility. As seen in both FIGS. 4A and 4B, each of the respective legs 400, 420 includes a horizontal offset (HO), in the direction of the bend in that leg relative to the point of attachment of that leg to the body 204, to effect proper responsiveness of the leg to vibrations that the vibration generator 216 (FIG. 2) imparts during operation.

Referring back to FIG. 2, in this embodiment the vibration generator 216 includes a rotational electric motor 216M and an eccentric weight 216W attached to the rotor of the motor so that when the motor is energized, the motor drives the excentric weight, which causes the microrobot 200 to vibrate. The rotational axis 216A of the motor 216M and eccentric weight 216W is parallel to each of the two rows of legs 212, and the location of the eccentric weight is offset from, here, forward of, the location, in the x-y plane, of the center of gravity of the two rows of legs 212. In this embodiment, the vibration generator 216 includes a motor controller 216C that responds to motor-control commands, including commands that control the direction of rotation of the eccentric weight 216W. The direction of rotation of the eccentric weight 216W and its location relative to the center of gravity of the legs determines the steering direction of the microrobot 200. In addition, the backward curvature of the legs 212, in combination with the vibrations imparted into the microrobot 200 by the driven eccentric weight 216W, causes the microrobot to move “forward,” i.e., in a direction generally along the local x-axis shown in FIG. 2. Consequently, controlling the rotational direction of the eccentric weight 216W controls the forward movement of the microrobot 200 as well as the yaw direction of the microrobot. In some embodiments, when the motor 216M is controlled to drive the eccentric weight 216W at some regions of high frequency usually higher than the resonance frequency of the microrobot 200, the microrobot moves generally backward. However, the speed of backward movement is lower than the forward movement. Careful switching of the directionality that the motor 216M drives the eccentric weight 216W can cause well-controlled rearward movement of the microrobot.

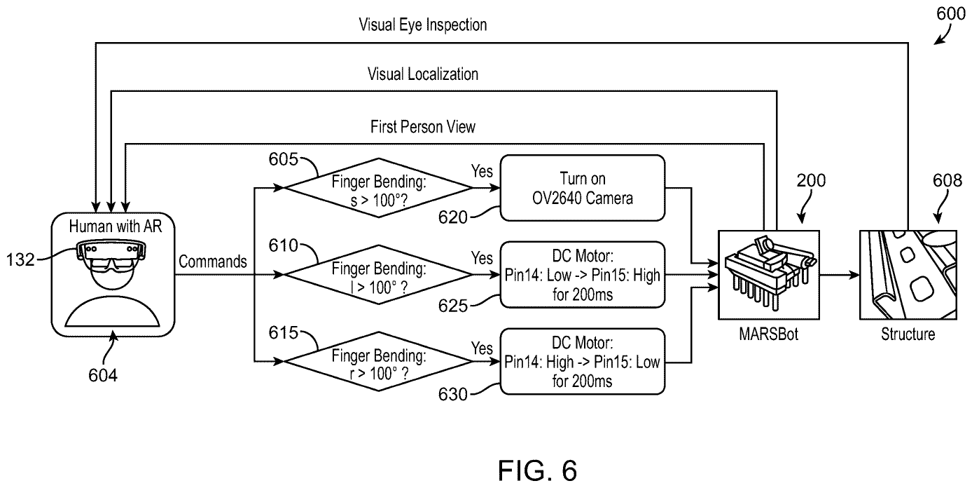

For example, and referring to FIG. 5, and also to FIGS. 2 and 1 as the first numeral in each of the element identifiers suggests, if a user (not shown) wants to move the microrobot 200 from point A to point B some distance away, the user would use an AR system (such as the AR system 108 of FIG. 1) and one or more hand gestures that cause the motor controller 216C to cause the motor 216M to alternatingly reverse the rotational directionality of the eccentric weight 216W. As those skilled in the art will readily appreciate, this continual reversing of the rotational directionality of the eccentric weight 216W causes the microrobot 200 to proceed along a generally zig-zag pathway 500 composed of alternating segments in which the microrobot is proceeding forward, with either a positive or negative yaw angle Ψ, depending on the rotational direction of the eccentric weight 216W. When the alternating of the rotational directionality of the eccentric weight 216W is performed at a constant frequency and a constant amplitude, the zig-zag path 500 will be generally as shown, with the side-to-side directionality of the path effectively averaging to a straight-line average path 504 connecting points A and B with one another. Non-constant frequencies and/or non-constant amplitudes will produce average paths having non-linear trajectories.

In an example of user hand gestures that cause the microrobot 200 to proceed along a zig-zag path, such as the zig-zag path 500 of FIG. 5, the AR system may generate a proceed-left MR control command based on a first gesture (e.g., thumb bend) and generate a proceed-right MR control command based on a second gesture (e.g., a middle finger bend) that is different from the first gesture. Here, the user would alternatingly bend her/his thumb and middle finger. In another example of user hand gestures to proceed along a zig-zag path, such as the zig-zag path 500 of FIG. 5, the AR system may generate a proceed-forward MR control command based on a single user hand gesture (e.g., simultaneously bending both his/her index and middle fingers). The proceed-forward MR control command may, for example, cause the motor controller 216C to start repeatingly causing the motor 216M to continually switch the rotational directionality of the eccentric weight 216W at a constant frequency and a constant amplitude so as to cause the microrobot 200 to move along a straight-line average path, such as the straight-line average path 504 of FIG. 5. To stop the progress of the microrobot 200, i.e., to stop the motor controller 216C from repeatingly causing the motor 216M to continually switch the rotational directionality of the eccentric weight 216W, the user may simultaneously straighten her/his bent index and middle fingers, which the AR system classifies as a stop-forward-progress MR control command that signals the motor controller 216C to stop the motor 216M. These examples are simply illustrative and non-limiting.

The example vibration generator 216 has a single rotational motor 216M driving a single eccentric weight 216W for generating the vibration necessary to cause the microrobot 200 to move. However, in other embodiments the vibration generator may use more than one rotational motor, more than one eccentric weight, and/or one or more vibration-generating mechanisms other than a motor/eccentric weight combination. For example: a single rotational motor can drive a plurality of eccentric weights; a plurality of rotational motors can drive a corresponding plurality of eccentric weights (e.g., two single-rotational-direction motors may be used to drive the eccentric weights in opposite directions, which directionality of movement of the microrobot 200 being determined by the on-off states of the two motors; and one or more linear-motor-based impact mechanisms may be used to cause the directional vibrations; among others. Fundamentally, there is no limitation on the type of vibration generator used as long as it meets the designed parameters, such as, but not limited to, any weight constraint, any power-consumption constraint, and any performance constraint, among others. It is also noted that the design process for creating the microrobot 200 includes tuning the vibration characteristics of the microrobot that the microrobot exhibits in response to the vibrations imparted by the vibration generator 216. This tuning is performed to optimize the microrobot 200 for moving and steering and can include adjusting parameters such as the overall weight of the microrobot 200, the operating characteristics of the motor(s) (e.g., motor 216M), the configuration and mass of the eccentric weight(s) (e.g., eccentric weights 216W), and/or the number, configuration, and structure(s) of the legs 212, among others.

The embodiment of the microrobot 200 in FIG. 2 includes a visible-light video camera 224 for acquiring images of the deployment environment (not shown, but see, e.g., the deployment environment 112 of FIG. 1) and streaming those images to an AR system, such as the AR system 108 of FIG. 1. As discussed above, a user (not shown) can use the video camera 224 to acquire real-time images for navigating the microrobot 200 and/or to acquire images for visual inspection of any target object (not shown) within the deployment environment. The video camera 224 can be any suitable video camera and, in some embodiments be part of a camera module 224M. In an example, the camera module 224M is an ESP32-CAM camera module available from Shenzhen HiLetgo Technology Co., Ltd., Shenzhen, China, but many other cameras/camera modules can be used. The ESP32-CAM module includes a WI-FI® radio (not shown), which functions as a wireless data-communications system of the microrobot 200 (see, e.g., FIG. 1 and the wireless data-communications system 128). In this example, the camera module 224M also includes hardware (not shown), including a microprocessor and memory, that executes and stores software (not shown) for controlling the operation of the video camera 224, in some cases in response to camera-control-type MR-control commands from the AR system, and issuing movement-type MR-control commands from the AR system to the motor controller 216C. It is noted that in other architectures, the duties of controlling the video camera 224 and vibration system 216 may fall on components aboard the microrobot 200 other than the camera module 224M and the motor controller 216C. Those skilled in the art will readily understand how to implement alternative system architectures of the control system(s) aboard the microrobot 200, such that detailed examples are not needed herein for those skilled in the art to practice the innovations of the present disclosure to their fullest scopes without undue experimentation.

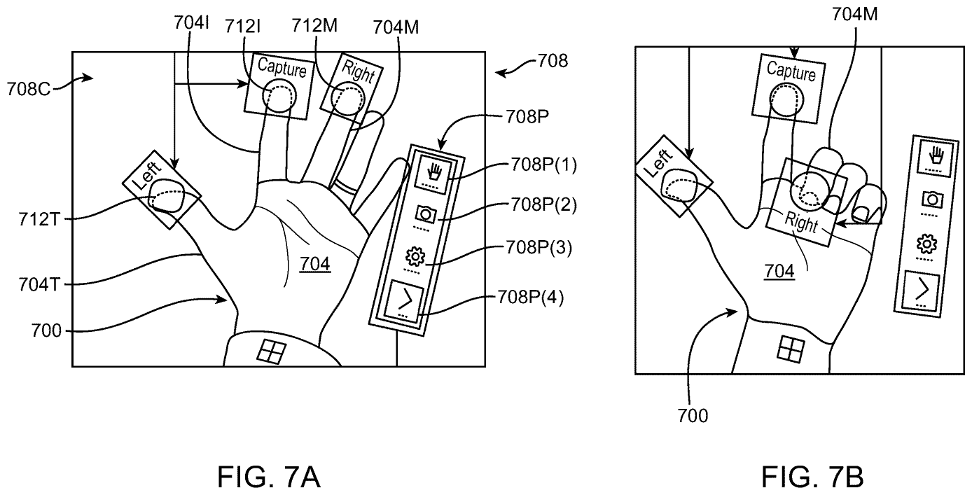

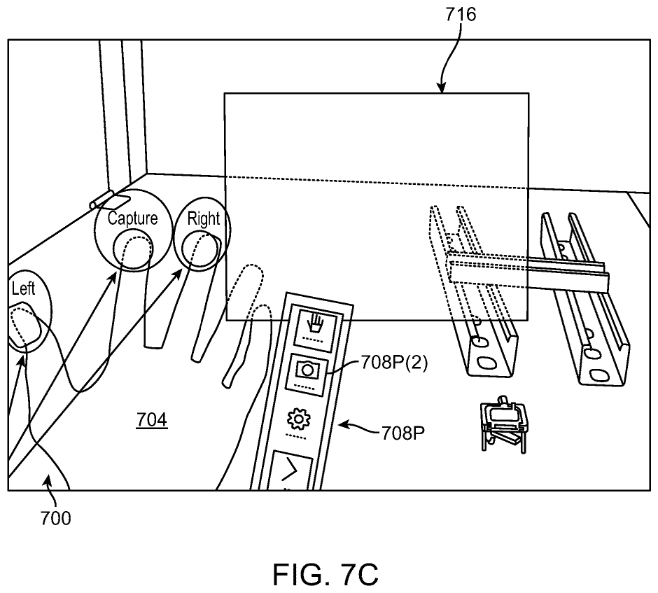

FIG. 6 illustrates an example inspection scenario 600 that a user 604 can perform relative to a deployment environment, here, a structure 608 (specifically, a channel strut in this example; also seen in FIG. 7C) to be inspected, using an MR system of the present disclosure, such as the MR system 100 of FIG. 1. Referring now to FIG. 6 and also to FIGS. 1 and 2 as the first numeral in each element identifier suggest, in this example the AR system 108 is configured so that the headset 132 allows the user 604 to see livestreamed video from the video camera 224 onboard the microrobot 200 as well as providing a first person view of the environment surrounding the user, which can include some or all of the deployment environment 112. Also in this inspection scenario 600, the AR system 108 is configured to: at decision block 605, determine and classify a bending of a first hand-digit (i.e., thumb or finger) to an angle of greater than 100° (i.e., a threshold bending angle) as the gesture to start livestreaming of images from the video camera 224 to the AR system and to generate a camera-on MR-control command; at decision block 610, determine and classify a bending of a second hand-digit to an angle of greater than 100° as the gesture to cause the vibration generator 216 to operate so as to cause the microrobot 200 to move forward and to the left and to generate a proceed-leftwardly MR-control command; and at decision block 615, determine and classify a bending of a third hand-digit to an angle of greater than 100° as the gesture to cause the vibration generator to operate so as to cause the microrobot to move forward and to the right and to generate a proceed-rightwardly MR-control command. Correspondingly, in this example, the microrobot 200 is designed and configured to: at block 620, respond to the camera-on MR-control command by turning the video camera on; at block 625, respond to the proceed-leftwardy MR-control command by causing the motor 216M to rotate the eccentric weight 216W in a first direction; and at block 630 respond to the proceed-rightwardly MR-control command by causing the motor to rotate the eccentric weight in a second direction opposite to the first direction. It is noted that the threshold bending angle of greater than 100° is merely an example and that other threshold bending angles can be used. In some embodiments, the threshold bending angle is user-adjustable so that a user can set the threshold bending angle to any angle that the user finds most intuitive for the control process. In some embodiments different threshold bending angles can be set for different hand digits.

FIG. 7A shows a view that a user 700 would see displayed by a headset, such as the headset 132 of the AR system 108 of FIG. 1, when wearing the headset. Referring now to FIG. 7, and also FIG. 1 as the first numeral in each of the element identifiers suggest, in this example the user 700 is viewing his right hand 704, so the headset 132 is displaying real-time images (a single one of these images captured in FIG. 7A) of the user's right hand that the AR system overlays with a virtual MR-control interface 708. In this example, the real-time images are captured by the camera 136 onboard the headset 132, with the virtual MR-control interface 708 being added to the real-time images. It is noted that in other embodiments, the user's view of his right hand 704 may be a first-person view through one or more lenses (not shown) of the headset, with the virtual MR-control interface 708 being overlaid (e.g., by projection onto the lens(es)) onto the first-person view. In any case, those skilled in the art will readily understand how to overlay a virtual MR-control interface, such as the virtual MR-control interface 708 using known AR-display techniques.

In the embodiment of FIG. 7A, the virtual MR-control interface 708 includes a virtual control panel 708P and a virtual controller 708C. As described in detail below, the virtual control panel 708P allows the user 700 to make various selections that control the operation of the AR system 108 and the microrobot 200, and the virtual controller 708C allows the user 700 to cause the AR system to issue MR-control commands via various gestures that the user makes with digits of her/his left hand 704, here, the thumb 704T, the index finger 704I, and the middle finger 704M. In this example, the user's right hand is free to perform another task, such as a manual inspection task. In some embodiments, the AR system 108 (FIG. 1) may be configured so that the control-gesturing hand that the MR-control interface 708 recognizes may be user-settable. In some embodiments, the AR system 108 (FIG. 1) may be configured so that it automatically recognizes (e.g., via object detection/recognition) which hand the user is using to make control gestures.

The virtual control panel 708P includes a number of virtual soft controls presented as icons, here, a controller toggle switch 708P(1), a livestream toggle switch 708P(2), a settings button 708P(3), and a quit button 708P(4). The user 700 can select any of these soft controls using her/his index finger 704I to virtually select that control using any known virtual-selection techniques and virtual-control-selection algorithms. In this example, the controller toggle switch 708P(1) controls the on-off state of the virtual controller 708C, the livestream toggle switch 708P(2) controls the on-off state of the camera 224 aboard the microrobot 200, the settings button 708P(3) controls the open-closed state of a settings menu (not shown) that allows the user 700 to control various system settings, and the quit button 708P(4) allows the user to exit a current control session.

In this example, the virtual controller 708C and the underlying virtual-controller algorithms, object-detection algorithms, and gesture-classification algorithms (not shown, but contained in the hardware 144H and software 144S of the controller 144 of the AR system 108) are designed and configured to control three functions of the microrobot 200, namely, moving leftwardly forward, moving rightwardly forward, and capturing images from the camera 224 onboard the microrobot 200. In this example, control of leftward movement is performed by gesturing of the user's thumb 704T, control of rightward movement is performed by gesturing of the user's middle finger 704M, and control of image capturing is performed by gesturing of the user's index finger 704I.

It is noted that the gestures illustrated are examples and nonlimiting. Other gestures can be used. For example, a gesture by a different hand digit can be used to trigger forward movement, perhaps with the software 144H of the controller 144 (FIG. 1) being configured to cause the microrobot 200 to continue to move forward until the user releases the gesture, i.e., returns the hand digit to a neutral position. As another example, a gesture can be a pointing of one of the user's hands that is in the field of view of the AR system 108. For example, the pointing may be to a certain location visible to the user in the AR headset 132, and the software 144S may correlate the pointing to that gesture and then generate the appropriate movement commands for causing the microrobot 200 to move to that location. As a further example, the software 144S of the controller 144 may recognize a certain gesture as an indication that the user wants to use image processing, such as an artificial-intelligence-based image processing, on images received from the microrobot 200 to extract interesting features, such as, for example, defects for structural health monitoring applications, and then display such images in a holographic view within the AR headset 132. Alternatively to gesturing in this last example, the AR system 108 could display a virtual button (not shown, but see other examples below), that allows the user to invoke the image processing and display. Many other gestures and functions are possible.

When the user 700 turns on the virtual controller 708C using the controller toggle switch 708P(1) in the virtual control panel 708P and when the user's left hand 704 is present in the field of view of the headset 132 with the palm-side facing toward the headset, the controller 144 causes the headset to display visual control indicia, here, markers 712T, 712I, and 712M that overlie, respectively, the tips of the user's thumb 704T, the user's index finger 704I, and the user's middle finger 704M, and corresponding instructive labels, here, “Left”, “Capture”, and “Right”, respectively, for the user. In this example, the controller 144 of the AR system 108 has highlighted the controller toggle switch 708P(1) (e.g., in green) to indicate that the virtual controller 708C is in its on state. As those skilled in the art will readily understand, the controller 144 uses suitable algorithms for determining the locations of the digit tips and overlaying the corresponding visual control indicia onto those digit tips. It is noted that the palm-up, digit-bending-based gesturing of this example is a unique and intuitive way of controlling a robot, such as the microrobot of FIG. 2.

In this example, the controller 144 generates a relevant MR-control command when it detects and classifies the user's bending of any one of his/her thumb 704T, index finger 704I, and middle finger 704M to an angle of 100° or greater. FIG. 7B illustrates the user 700 bending her/his middle finger 704M to an angle greater than 100° (here, about 180°). The controller 144 detects this bending and consequently, generates a proceed rightwardly MR-control command and causes the AR system 108 to send this command to the microrobot 200 via the wireless data link 120. In response to receiving the proceed rightwardly MR-control command, the microrobot 200 energizes the vibration generator 216 so as to drive the eccentric weight 216W in the rotational direction that causes the microrobot to move forward and to the right. Those skilled in the art will readily appreciate that the gesturing and the parts of the user's hand 704 involved with the control gesturing may be different from the gesturing of certain digits just described above. For example, the gesturing may be rotation of the hand, including direction of the rotation, among others.

Still referring to FIGS. 1 and 2 as the first numeral in each element identifier suggests, FIG. 7C shows another view that the user 700 would see when she/he has turned on livestreaming via the livestream toggle switch 708P(2) in the virtual control panel 708P. As seen in FIG. 7C, the controller 144 of the AR system 108 has highlighted the controller toggle switch 708P(2) (e.g., in green) to indicate that the virtual controller 708C is in its on state. When livestreaming is turned on, the controller 144 causes the headset 132 to display the livestreamed images from the camera 224 onboard the microrobot 200 in a livestream window 716 within the view that the user 700 sees via the headset. As mentioned above, the user 700 can use the livestreamed images displayed in the livestream window 716 to navigate the microrobot 200 when it is out of either the first-person view of the user or the view of the camera 136 onboard the headset. The user 700 may additionally or alternatively use the livestreamed images displayed in the livestream window 716 to capture any one or more desired ones of the livestreamed images, for example, to save such captured image(s) for later use, such as for further analysis, appending to an inspection report, and/or archiving, among other uses. In some embodiments, captured images may be stored in any one or more suitable locations, such as onboard the microrobot 200, onboard the AR system 108, and/or at a location outside of the MR system 100, such as in a server (not shown) connected to the network 116.

In addition to the hand-gesturing embodiment described above, further embodiments provide for generating robot control signals based on tracking movements of other portions of a human operator's body and/or physiological signals of the operator. In some implementations, one or more body movements, including, by way of non-limiting example, arm movement, shoulder movement, head movement, eye movement, leg movement, foot movement, toe movement, tongue movement, or combinations thereof, are detected and quantified by one or more sensors and processed to produce corresponding control inputs for a robot, such as the microrobot 200 of FIG. 2, and other aspects of an overall MR system, such as the MR system 100 of FIG. 1. For example, detected shoulder motion may be mapped to translational movement of the robot, detected head orientation may be mapped to robot camera orientation, detected eye movement may be mapped to selection or activation of robot functions, and detected leg or foot movement may be mapped to locomotion control of the robot. In further embodiments, physiological signals indicative of cognitive intent may be acquired from the operator, such as electroencephalogram (EEG) signals generated by voluntary neural activity of the operator's brain, and processed to derive control commands representing intended robot actions.

The foregoing movements and physiological signals may be detected using one or more tracking systems implemented via computing hardware and associated sensors, using hardware and techniques known in the art. In some embodiments, a video-based tracking system includes one or more image-capture devices and one or more processors configured to execute computer-readable instructions that analyze image data to identify, for example, body parts, joint locations, gaze direction, and/or motion trajectories, and to generate corresponding control signals. In other embodiments, the tracking system includes inertial or motion-sensing devices, such as accelerometers and gyroscopes, configured to output sensor data representative of body movement, or eye-tracking systems configured to output gaze or blink data. In further embodiments, a neural-signal acquisition system includes one or more EEG sensors configured to detect electrical brain activity and one or more processors configured to filter, classify, and interpret the detected signals to generate robot control commands. Each such tracking system produces machine-readable signals that are processed by one or more processors to generate control instructions transmitted to the remote robot. Any of the foregoing tracking systems may be used individually or in combination with one another, and further may be used individually or in combination with the hand-gesturing embodiment described above, thereby enabling single-modal or multi-modal control of the remote robot based on detected physical movements and/or physiological signals of the operator.

In an example data flow, raw sensor data is acquired from one or more sensors, such as image-capture devices, motion sensors, eye-tracking sensors, or neural-signal sensors. The raw sensor data is provided to one or more processors configured to perform signal conditioning and feature extraction, including, for example, filtering, normalization, segmentation, pose estimation, motion vector determination, gaze vector determination, and/or neural-signal classification. The extracted features are then mapped, using one or more control models and/or algorithms, to corresponding control parameters or control vectors representing desired robot movements, orientations, tool actions, and/or operational states. The resulting control parameters or control vectors are transmitted to the remote robot and used to drive one or more actuators, effect robot motion, adjust robot pose, and/or initiate other robot functions.

The tracking and control algorithms associated with the additional embodiments described herein may be implemented using the same or similar computing systems, processors, memory, and communication interfaces described elsewhere in the present disclosure. Those skilled in the art will readily appreciate that the image-processing algorithms, motion-analysis algorithms, eye-tracking algorithms, neural-signal processing algorithms, and/or control-mapping algorithms associated with the additional tracking modalities may be adapted, configured, and integrated to execute on the disclosed computing systems without undue experimentation.

Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A method of controlling, by a user having a hand, a mobile robot having a mobility system for moving the mobile robot in a deployment environment, wherein the mobility system is responsive to a plurality of movement commands to move the mobile robot, the method comprising:
providing, by a headset of an augmented-reality system to a user wearing the headset, a view of features within the deployment environment;
capturing, by a first camera of the augmented-reality system, a first gesture that the user makes with the hand;
translating the first gesture into at least one of the movement commands; and
transmitting the at least one of the movement commands to the mobile robot.

2. The method of claim 1, wherein the providing of the view includes providing a direct view of the features within the deployment environment.

3. The method of claim 1, wherein the providing of the view includes providing images of the features within the deployment environment.

4. The method of claim 3, wherein the providing images of the features within the deployment environment includes using artificial-intelligence-based image processing.

5. The method of claim 3, wherein the mobile robot includes a second camera, and the providing of the images includes providing live-streamed images.

6. The method of claim 5, wherein the second camera is responsive to a camera-control command, and the method further comprises:
capturing, by the first camera, a second gesture of the user, wherein the second gesture is different from the first gesture;
translating the second gesture into the camera-control command; and
transmitting the camera-control command to the mobile robot for controlling the second camera.

7. The method of claim 6, wherein the camera-control command comprises a start-stream command.

8. The method of claim 1, further comprising, when the user views the hand using the headset, causing the headset to display an overlay, relative to the hand, containing a plurality of visual control indicia.

9. The method of claim 8, wherein: the hand is palm up and the first gesture is made with digit bending-based gesturing.

10. The method of claim 8, wherein: the first gesture includes a pointing of the hand while the hand is in a field of view of the augmented-reality system.

11. The method of claim 8, wherein:
the hand has a plurality of digits that each include a digit tip; and
the causing of the headset to display the overlay includes causing the headset to display the visual control indicia so as to overlay corresponding ones of the digit tips.

12. The method of claim 11, wherein the plurality of digits include a thumb, a first finger, and a second finger.

13. The method of claim 11, wherein a plurality of movement commands are mapped to differing ones of the digits.

14. The method of claim 13, wherein the plurality of movement commands are steering commands.

15. The method of claim 10, wherein each of the visual control indicia further includes a control label.

16. The method of claim 1, wherein:
the mobility system comprises a vibrational mobility system that includes a vibration generator having first and second vibrational directionalities that, when active, cause the mobile robot to move in corresponding first and second differing directions;
a first movement command of the movement commands causes the vibration generator to operate in the first vibrational directionality; and
a second movement command of the movement commands causes the vibration generator to operate in the second vibration directionality.

17. The method of claim 16, wherein the vibration generator comprises a rotational generator having first and second rotation directions that are opposites of one another, and the first and second vibrational directionalities are, respectively, the first and second rotation directions.

18. The method of claim 17, wherein the first movement command is mapped to the first gesture, and the second movement command is mapped to a second gesture different from the first gesture.

19. The method of claim 16, wherein the first and second movement commands are mapped to differing movements of one or more body parts of the user or to differing voluntary neural signals of the user.

20. A machine-readable storage medium containing machine-executable instructions for performing the method of claim 1.
